(19) United States
(12) Patent Application Publication
(10) Pub. No.: US 2005/0154587 A1
(43) Pub. Date: Jul. 14, 2005

(54) Voice enabled phone book interface for speaker dependent name recognition and phone number categorization

(75) Inventors: Mark Funari, Boston, MA (US); Jordan Cohen, Gloucester, MA (US)

Correspondence Address: WILMER CUTLER PICKERING HALE AND DORR LLP, 60 STATE STREET, BOSTON, MA, 02109, US

(73) Assignee: Voice Signal Technologies, Inc., Woburn, MA (US)

(21) Appl. No.: 10/935,690

(22) Filed: Sep. 7, 2004

Related U.S. Application Data
(60) Provisional application No. 60/501,973, filed on Sep. 11, 2003.

(51) Int. Cl. G10L 15/00

(52) U.S. Cl. 704/247

(57) ABSTRACT

A method of operating a mobile communication device that includes a speaker independent recognizer and a memory storing phonebook including a plurality of names, the method involving: generating a first voice signal from a first voice input received from a user, the first voice input specifying a selected one of a plurality of names; comparing the first voice signal to a plurality of voice tags that are stored in the device to identify the selected name in the phonebook; generating a second voice signal from a second speech input received from the user, the second voice input specifying a selected one of a plurality of phone number types; using the speaker independent recognizer to identify the selected phone number type; retrieving a phone number that is stored in association with the identified type for the identified name; and initiating a call to the phone number associated with the identified type for the identified name.

This application also claims the benefit of U.S. Provisional Application No. 60/501,973, filed Sep. 11, 2003.

### TECHNICAL FIELD

This invention generally relates to mobile communications devices with internal phone books.

### BACKGROUND OF THE INVENTION

In many modern cell phones, it is possible to have a few “voice tags” associated with phone numbers, so that users can call frequently called numbers by simply saying “John Hansen” or “call mom”. In essence, these phones store the acoustic signal and use old well know techniques to compare the spoken word or phrase with the stored acoustic signals to find a best match. Though this technique has drawbacks. For example, the technique does not work well in noisy environments. However, it also has advantages, namely, it is very inexpensive in terms of required computational resources as compared to providing real speech recognition functionality.

The voice tag is trained using a manual process whereby the user navigates to the phone book, enters a phone number manually, and then is prompted for one or more utterances by the system. The phone then manipulates the acoustic utterances to make a template. After that, the user can dial the phone with a voice tag, during which the user's prompted utterance is matched with all the available templates, and the phone number associated with the best matching template is called.

In earlier versions of these voice tag systems, the user had to manually go through a menu system to get to the number entry application. This process tended to be tedious and required that the user be looking at the device while physically pressing the required sequence of keys to enter the data. Such manual entry required close coordination and attention of the user, especially if it became necessary to correct the entered number.

To improve ease of use, some more recent cell phones began including speaker independent recognition among the functions available in the phone along with a limited dictionary of words or numbers. One example of such a phone is the Samsung a500, which in addition to speaker independent recognition also includes a phone book that offers alternate storage locations for each entered name. This made the entry of names and numbers hands free, or at least much less cumbersome.

In the phones in which voice tags are used, the user must enter a separate voice tag for each phone number associated with a person. Thus “john home” “john office” and “john mobile” each require a different voice tag. As a rule, the voice tags require a considerable amount of very limited memory storage space. For example, voice tags typically require about 2-4 kbytes each. So, because of this only a few can be allowed, e.g. 6 to 20. This means that the small number of possible voice tags can easily be used up on an even smaller number of people to be called. In addition, the user must remember the exact form of his utterance in order to reference the phone number.

### SUMMARY OF THE INVENTION

In general, in one aspect, the invention features the coupling of dialing-by-voice-tag technology, which tends to be very inexpensive computationally, with the structure of the phone book. That is, it features the use of voice dependent matching of acoustic signals to identify the person whose phone number is to be used along with the use of speaker independent recognition to determine which phone number for the person to call.

In general, in another aspect, the invention features a method of operating a mobile communication device that includes a speaker independent recognizer and a memory storing phonebook including a plurality of names. The method includes: generating a first voice signal from a first voice input received from a user, the first voice input specifying a selected one of a plurality of names; comparing the first voice signal to a plurality of voice tags that are stored in the device to identify the selected name in the phonebook; generating a second voice signal from a second speech input received from the user, the second voice input specifying a selected one of a plurality of phone number types; using the speaker independent recognizer to identify the selected phone number type; retrieving a phone number that is stored in association with the identified type for the identified name; and initiating a call to the phone number associated with the identified type for the identified name.

Other embodiments include one or more of the following features. Each of the plurality of voice tags is a corresponding template. The plurality of voice tags is generated from spoken input from the user speaking the corresponding name. The method also includes prompting the user to specify a name from among the plurality of names stored in the phonebook; and, after prompting the user, receiving the first voice input from the user. The method also includes, after comparing the first voice signal to a plurality of voice tags, prompting the user to identify one of the plurality of phone number types. The plurality of phone number types includes selections from the group consisting of home, office, fax, pager, and mobile, more specifically, it includes home, office, and mobile. The mobile communications device is a cellular telephone.

In general, in another aspect, the invention features a method of implementing a phonebook on a mobile communication device. The method includes: storing a plurality of voice tags each of which is associated with a different name of a corresponding plurality of names; defining a set of types of phone numbers; and for each voice tag storing a corresponding plurality of phone numbers, each phone number of the corresponding plurality of phone numbers for that voice tag being associated with a different type from among said set of types.

Other embodiments include one or more of the following features. Each of the plurality of voice tags is a corresponding template that is generated from spoken input from the user speaking the corresponding name. The plurality of types includes selections from the group consisting of home, office, fax, pager, and mobile, and more specifically, it includes home, office, and mobile. The mobile communications device is a cellular telephone.

In general, in still another aspect, the invention features a method of operating a mobile communication device that includes a phonebook and a speaker independent recognizer. The method involves: for each of a plurality of names storing a voice tag of the name and a plurality of phone numbers each of which is identified by a different corresponding type of a plurality of phone number types; receiving a first voice input from the user, wherein the first voice input specifies a selected one of the plurality of names; generating a first voice signal from the first speech input; comparing the first voice signal to the voice tags for the plurality of names to identify the selected name in the phonebook; receiving a second voice input from the user, wherein the second voice input specifies a selected one of the plurality of phone number types; generating a second voice signal from the second speech input; using the speaker independent recognizer to identify the selected type; and initiating a call to the phone number associated with the identified type for the identified name.

In general, in still yet another aspect, the invention features a mobile communications device including: an input circuit for receiving spoken input from a user; a wireless transmitter circuit; a digital processing subsystem; and memory subsystem storing a phonebook containing a plurality of names, wherein the memory subsystem also stores a plurality of voice tags each of which corresponds to a different name among the plurality of names in the phone book and stores, for each voice tag among the plurality of voice tags, a corresponding plurality of phone numbers, each phone number of the corresponding plurality of phone numbers for that voice tag being associated with a different type from among a set of types of phone numbers, and the memory system also stores code for causing the digital processing subsystem to access numbers in the phone book based on spoken input received through the input circuit and to call the accessed number via the wireless transmitting circuit.

Other embodiments include one or more of the following features. The memory subsystem also stores code for implementing a speaker independent recognizer and the code stored in the memory subsystem also causes the digital processing system to: compare a first voice signal to a plurality of voice tags that are stored in the memory subsystem to identify a selected name in the phonebook, wherein the first voice signal is derived from a first voice input received by the input circuit, the first voice input specifying a selected one of a plurality of names; use the speaker independent recognizer to process a second voice signal derived from a second speech input received by the input circuit to identify a selected one of a set of phone number types, the second voice input specifying the selected one of the phone number types; retrieve a phone number that is stored in association with the identified phone number type for the identified name; and initiate a call through the wireless transmitter circuit to the phone number associated with the identified phone number type for the identified name.

At least one substantial advantage of one or more embodiments of the invention is a great improvement in storage efficiency for phone book entries that are accessed by voice tags. Another advantage for at least some embodiments is that a user who might be vision impaired can nevertheless program the phone book without having to look at a screen.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1a is a flow chart of the add-a-voice-tag application, which implements a process by which voice tags and associated phone numbers are added to the phone through spoken inputs.

FIG. 1b is a flow chart of the number dial application, which implements a process by which the user calls a number from the phone book by using spoken inputs.

FIG. 2 shows a high-level block diagram of a smartphone.

### DETAILED DESCRIPTION

In the phones that have speaker-independent number recognition capability and also use voice tags to store telephone numbers, it is possible to store many more numbers than the standard offering without using substantially more memory. In the described embodiment, this is accomplished by combining voice tags for names with speaker independent recognition of categories. Thus, for each voice tag that is stored, the phone also stores multiple phone numbers each one identified or indexed by a corresponding one of the available categories( e.g. “home,” “office,” “mobile,” “fax,” and “pager”). The user accesses the set of numbers for a particular person by speaking the person's name. When that name is found among the group of stored names by finding the matching voice tag, the system then prompts the user for the category. In this case, however, when the user says the desired category, the phone uses its speaker independent recognition capabilities to recognize which category the user identified. So, instead of using a voice tag for each name/category combination, the voice tag is used only for the name and the categories are identified using the speaker independent recognition engine or program.

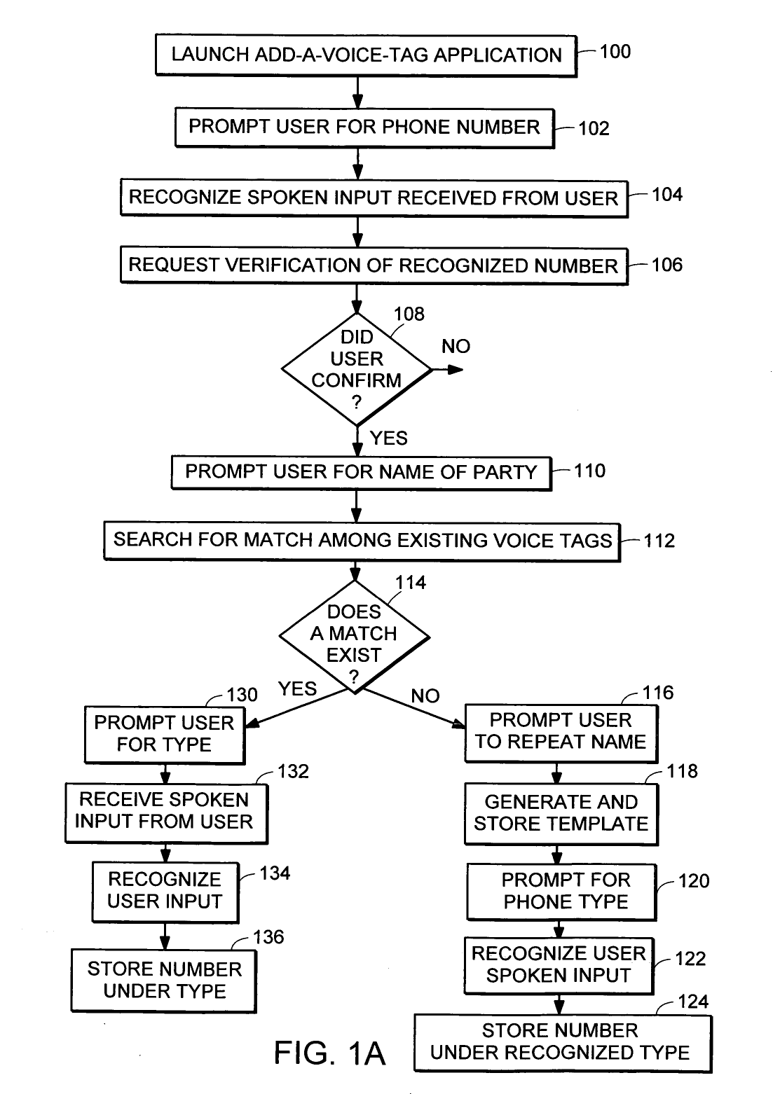

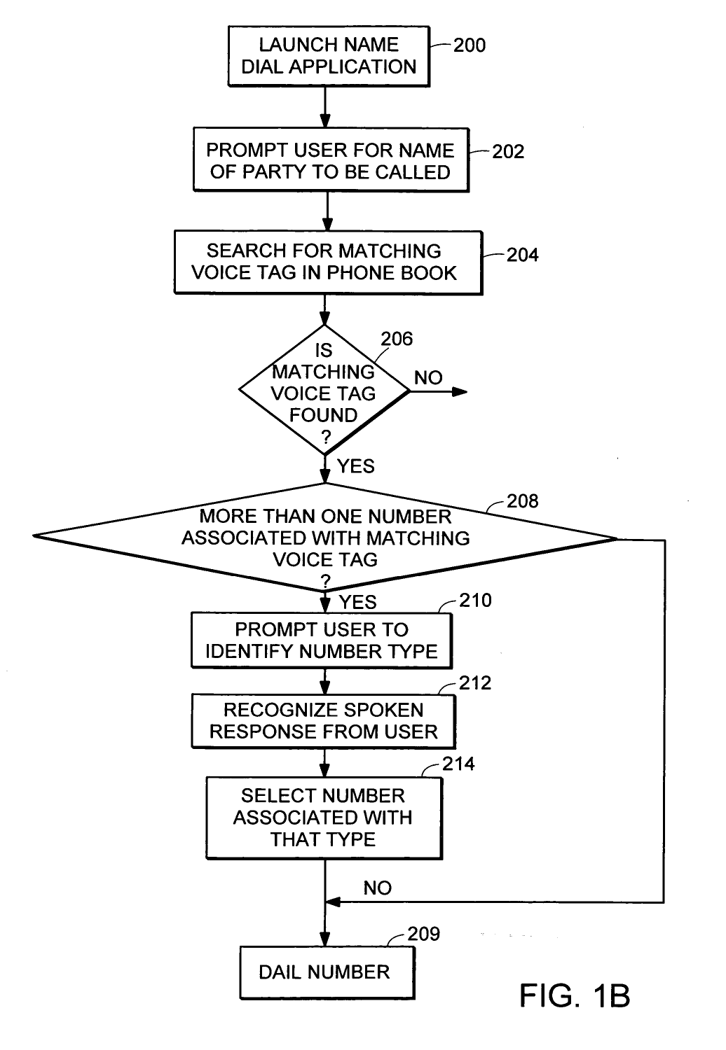

A more detailed description of the operation of the phone is shown in FIGS. 1a and 1b which presents a flow chart of its operation.

Referring to FIG. 1a, to access this functionality, the user launches the “add-a-voice-tag” application either from the menu or from a dedicated button or from a voice menu (step 100). Since this is a multimodal interface, the user typically has multiple options for inputting commands and information. In other words, he can use a standard numerical keypad, a multi-tap keypad, or voice. However, since the voice input capabilities are more directly related to the features that are most relevant here, it is the voice recognition interface that will be discussed as the selected mode, with the understanding that the other modes are also available.

Once the “add-a-voice-tag” application has been launched, it causes the phone to prompt the user for a phone number (step 102). The user responds by speaking the phone number of the party that is to be called. Upon receiving the speech signal representing the phone number, a speaker independent recognition engine that is implemented in the phone with an associated vocabulary of numbers recognizes the number and presents the results to the user (step 104). Then, the phone prompts the user for confirmation that the number was correctly recognized (step 106). After the user confirms the number (step 108), the program causes the phone to prompt the user to speak the name of the party (step 110).

At this stage of the operation, an option exists to also implement an n-best feature such as that which is described in U.S.Ser. No. 10/783,518, titled “Method of Producing Alternate Utterance Hypotheses Using Auxiliary Information on Close Competitors,” incorporated herein by reference. According to that feature, if the recognition engine generates other numbers that are almost as likely as the best choice (or closest competitors), the phone presents the user with an ordered list of the n-best guesses with the most likely choice at the head of the list and the least likely choice at the end of the list. The user then picks the correct one from the list. Typically, the correct one will be the first choice on that list, and in many other situations the computed confidence associated with the best choice will be so much greater than any alternative possibilities that the program will simply select it without presenting the alternatives.

After the user has spoken the name of the party for which the information is being stored and the phone as received that input, the application performs an acoustic match to find a name among the existing, previously stored voice tags that matches the spoken name (step 112). If no match is found (step 114), indicating that no record has yet been created for that name, the phone prompts the user to repeat the name one or several times and from the spoken inputs of that name (step 116), and then generates and stores a template (or voice tag) for that name (step 118). After the template is stored, the program causes the phone to prompt the user to specify the type (or category) of phone number that is to be added (i.e., “home,” “office,” “mobile,” “fax”, “pager,” or whatever other types the application has defined) (step 120). Using the speaker independent recognition engine with an associated vocabulary of available categories, the phone recognizes the category selected by the user (step 122) and stores the number in association with the selected name and category (step 124). In other words, if the voice tag is unique, then the entire database entry associated with that tag is created at this time.

Back in step 114, if it is determined that there is already a voice tag stored for the name that was supplied by the user, the application finds the match and prompts the user to specify under which of the available categories the entered number should be stored (step 130). For example, the user might have previously entered a “home” number leaving the other categories still open. In that case, the application identifies the available categories to guide the users choices. The user says one of the prompted types, and upon receiving that input (step 132), the speaker independent recognition engine recognizes the type (step 134), and stores the number in the memory location associated with that name and number type (step 136).

Correction of a phone number uses a similar dialog to point to a number to be replaced, and the user can type or say the number.

Referring to FIG. 1b, the user may call any stored number by launching the name dial application (step 200). Once launched, the name dial application prompts the say the name of the party to whom the call is to be placed (step 202). The application then searches for a matching voice tag in the phone book (step 204). If a matching tag is found (step 206), the application determines whether there is more than one phone number associated with that tag (step 208). If no matching voice tag is found, the application reports this to the user. If there is only one number associated with the tag, the application causes the phone to dial that number (step 209). However, if it is determined that there are multiple numbers stored under that tag (e.g. a phone number for each of several categories), the application prompts the user to identify which number is desired (step 210). Upon receiving the user's spoken identification of the desired category, the speaker independent recognition engine recognizes the speech signal (step 212), selects the corresponding number (step 214), and dials that number (step 209).

The advantage of storing phone numbers by using categories that are recognized by the speaker independent recognition engine can be easily appreciated by comparing the number of different phone numbers that one can store using this approach with the total number that one can store using the conventional approach of one number per voice tag. In the phone that uses the conventional approach, the typical storage capacity assuming common limitations on available memory is twenty voice tags. Under this new approach, assuming the phone supports five categories, the number of voice tags is still twenty but the total number of phone numbers associated with those twenty voice tags would be 100. So, this provides an easy way to greatly expand the number of phone numbers that are accessible in an environment that uses voice tags.

It should be noted that all of the prompts that are issued by the phone as described above can be audio prompts (i.e., vocalizations of the phrase or word that is to be communicated to the user). Thus, the interface for entering and using the phone book can be entirely through speech and audio prompts so that the user need not look at the screen during these phases.

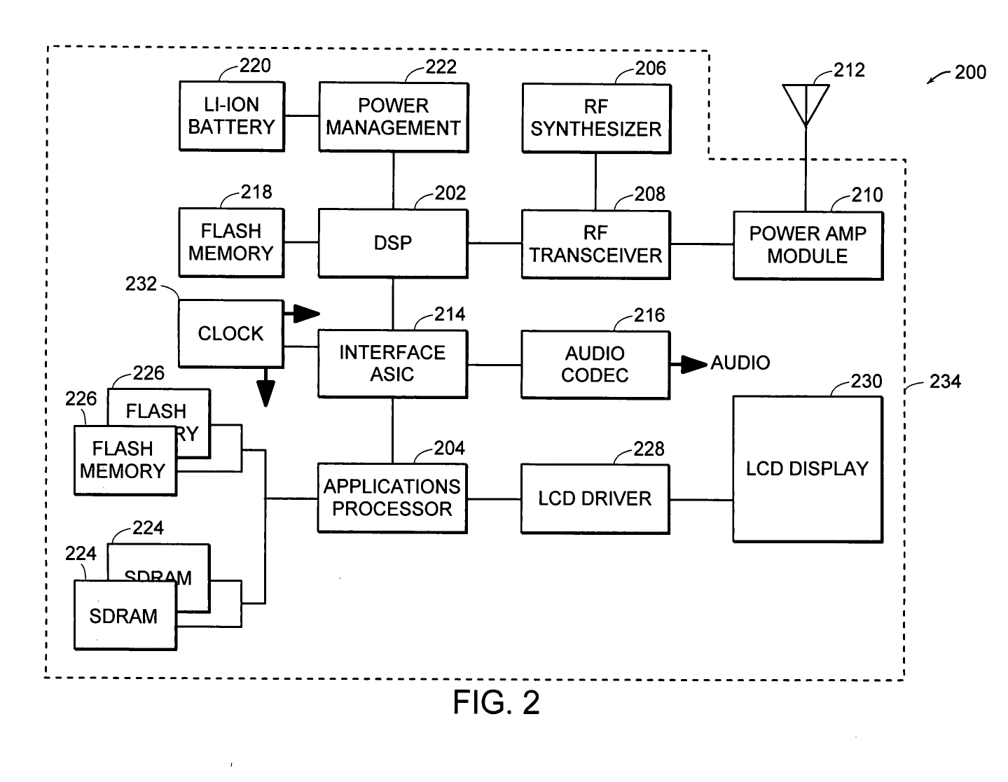

A typical platform on which such functionality can be implemented is a smartphone 200, such as is illustrated in the high-level block diagram form in FIG. 2. In this example, smartphone 200 is a Microsoft PocketPC-powered phone which includes at its core a baseband DSP 202 (digital signal processor) for handling the cellular communication functions (including for example voiceband and channel coding functions) and an applications processor 204 (e.g. Intel StrongArm SA-1110) on which the PocketPC operating system runs. The phone supports GSM voice calls, SMS (Short Messaging Service) text messaging, wireless email, and desktop-like web browsing along with more traditional PDA features.

The transmit and receive functions are implemented by an RF synthesizer 206 and an RF radio transceiver 208 followed by a power amplifier module 210 that handles the final-stage RF transmit duties through an antenna 212. An interface ASIC 214 and an audio CODEC 216 provide interfaces to a speaker, a microphone, and other input/output devices provided in the phone such as a numeric or alphanumeric keypad (not shown) for entering commands and information. DSP 202 uses a flash memory 218 for code store. A Li-Ion (lithium-ion) battery 220 powers the phone and a power management module 222 coupled to DSP 202 manages power consumption within the phone.

Volatile and non-volatile memory for applications processor 214 is provided in the form of SDRAM 224 and flash memory 226, respectively. This arrangement of memory is used to hold the code for the operating system, all relevant code for operating the phone and for supporting its various functionality, including the code for any applications software that might be included in the smartphone as well as the speaker independent recognition engine discussed above. It also stores the various dictionaries used by the speaker independent recognition engine and data for the phonebook and the voice tags.

The visual display device for the smartphone includes an LCD driver chip 228 that drives an LCD display 230. There is also a clock module 232 that provides the clock signals for the other devices within the phone and provides an indicator of real time.

All of the above-described components are packages within an appropriately designed housing 234.

Since the smartphone described above is representative of the general internal structure of a number of different commercially available phones and since the internal circuit design of those phones is generally known to persons of ordinary skill in this art, further details about the components shown in FIG. 1 and their operation are not being provided and are not necessary to understanding the invention.

Other embodiments are within the following claims.

1. A method of operating a mobile communication device that includes a speaker independent recognizer and a memory storing phonebook including a plurality of names, said method comprising:
generating a first voice signal from a first voice input received from a user, said first voice input specifying a selected one of a plurality of names;
comparing the first voice signal to a plurality of voice tags that are stored in the device to identify the selected name in the phonebook;
generating a second voice signal from a second speech input received from the user, the second voice input specifying a selected one of a plurality of phone number types;
using the speaker independent recognizer to identify the selected phone number type;
retrieving a phone number that is stored in association with the identified type for the identified name; and
initiating a call to the phone number associated with the identified type for the identified name.

2. The method of claim 1, wherein each of the plurality of voice tags is a corresponding template.

3. The method of claim 1, wherein each of the plurality of voice tags is generated from spoken input from the user speaking the corresponding name.

4. The method of claim 1, further comprising, after comparing the first voice signal to a plurality of voice tags, prompting the user to identify one of said plurality of phone number types.

5. The method of claim 4, further comprising, after prompting the user, receiving the first voice input from the user.

6. The method of claim 1 further comprising prompting the user to specify a name from among the plurality of names stored in the phonebook.

7. The method of claim 6, further comprising, after prompting the user, receiving the first voice input from the user.

8. The method of claim 1, wherein the plurality of phone number types includes selections from the group consisting of home, office, fax, pager, and mobile.

9. The method of claim 1, wherein the plurality of phone number types includes home, office, and mobile.

10. The method of claim 1, wherein the mobile communications device is a cellular telephone.

11. A method of implementing a phonebook on a mobile communication device, said method comprising:
storing a plurality of voice tags each of which is associated with a different name of a corresponding plurality of names;
defining a set of types of phone numbers; and
for each voice tag storing a corresponding plurality of phone numbers, each phone number of said corresponding plurality of phone numbers for that voice tag being associated with a different type from among said set of types.

12. The method of claim 11, wherein each of the plurality of voice tags is a corresponding template.

13. The method of claim 11, wherein each of the plurality of voice tags is generated from spoken input from the user speaking the corresponding name.

14. The method of claim 11, wherein the plurality of types includes selections from the group consisting of home, office, fax, pager, and mobile.

15. The method of claim 11, wherein the plurality of types includes home, office, and mobile.

16. The method of claim 1, wherein the mobile communications device is a cellular telephone.

17. A method of operating a mobile communication device that includes a phonebook and a speaker independent recognizer, said method comprising:
for each of a plurality of names storing a voice tag of the name and a plurality of phone numbers each of which is identified by a different corresponding type of a plurality of phone number types;
receiving a first voice input from the user, said first voice input specifying a selected one of said plurality of names;
generating a first voice signal from the first speech input;
comparing the first voice signal to the voice tags for the plurality of names to identify the selected name in the phonebook;
receiving a second voice input from the user, the second voice input specifying a selected one of said plurality of phone number types;
generating a second voice signal from the second speech input;
using the speaker independent recognizer to identify the selected type; and
initiating a call to the phone number associated with the identified type for the identified name.

18. A mobile communications device comprising:
an input circuit for receiving spoken input from a user;
a wireless transmitter circuit;
a digital processing subsystem; and
memory subsystem storing a phonebook containing a plurality of names, said memory subsystem also storing a plurality of voice tags each of which corresponds to a different name among the plurality of names in the phone book, said memory subsystem further storing, for each voice tag among said plurality of voice tags, a corresponding plurality of phone numbers, each phone number of said corresponding plurality of phone numbers for that voice tag being associated with a different type from among a set of types of phone numbers, and said memory system also storing code for causing the digital processing subsystem to access numbers in the phone book based on spoken input received through the input circuit and to call the accessed number via the wireless transmitting circuit.

19. The mobile communications device of claim 19 wherein the memory subsystem also stores code for implementing a speaker independent recognizer and wherein the code stored in the memory system also causes the digital processing system to:
compare a first voice signal to a plurality of voice tags that are stored in the memory subsystem to identify a selected name in the phonebook, wherein said first voice signal is derived from a first voice input received by the input circuit, said first voice input specifying a selected one of a plurality of names;
use the speaker independent recognizer to process a second voice signal derived from a second speech input received by the input circuit to identify a selected one of a set of phone number types, the second voice input specifying the selected one of the phone number types;
retrieve a phone number that is stored in association with the identified phone number type for the identified name; and
initiate a call through the wireless transmitter circuit to the phone number associated with the identified phone number type for the identified name.
